(19) United States
(12) Patent Application Publication
(10) Pub. No.: US 2009/0164522 A1
(43) Pub. Date: Jun. 25, 2009

(54) Computer forensics, e-discovery and incident response methods and systems

(75) Inventor: Andrew L. Fahey, Parker, CO (US)

Correspondence Address: BUCHANAN, INGERSOLL & ROONEY PC, POST OFFICE BOX 1404, ALEXANDRIA, VA, 22313-1404, US

(73) Assignee: e-fense, Inc., Centennial, CO (US)

(21) Appl. No.: 12/318,083

(22) Filed: Dec. 22, 2008

Related U.S. Application Data
(60) Provisional application No. 61/008,295, filed on Dec. 20, 2007.

(51) Int. Cl. G06F 17/30; G06F 9/44; G06F 15/16

(52) U.S. Cl. 707/104.1; 717/106; 709/202; 707/E17.044

(57) ABSTRACT

Systems and methods for collection of volatile forensic data from active systems are described. In an embodiment of the methods, a selected set of forensics data items can be selected. Runtime code capable of launching data collection modules from a removable storage device with little or no user input is generated and stored on the device. The collection of forensic data can then be accomplished covertly using the removable storage device by a person with minimal training. In another embodiment, pre-deployed agents in communication with servers and controlled by console software can collect forensic data covertly according to schedule, immediately at the command of an analyst using a remote administrative console, or in response to a triggering event.

### BACKGROUND

1. Field of the Invention

The invention relates to methods and systems for computer forensics, e-discovery, and incident response.

2. Description of the Related Art

The forensic acquisition of volatile data has been known for the last few years. The bootable incident response CD-ROM, Helix3™, has enabled users to acquire volatile data from systems since its release. Law enforcement and intelligence communities are aware of the practice of acquiring volatile data but have been very slow to accept it.

Volatile data analysis shows a wealth of information that has typically been ignored. With the advent of stronger encryption and newer operating systems such as Microsoft Vista, it has become very difficult for traditional forensic practices to yield useful data. This has led to a dichotomy in the forensics world. There is now a split between traditional forensics and what is referred to as live forensics. It is now imperative to capture volatile data before powering off a system and starting the traditional computer forensics imaging and analysis.

Unfortunately there is little training on the collection and analysis of volatile data. The tool sets to conduct such operations are limited and not well packaged. The Helix3™ CD alleviated this problem by pulling together the most effective incident response tools in use by various government agencies and corporate forensic professionals. This CD made it very easy for a trained individual to acquire not only physical images of hard drives but also the volatile data. Helix3™ has now become a standard in the forensics community around the world. Helix3™ continues to develop and improve, but there is a void that still needs to be filled.

The law enforcement and intelligence communities around the world need to be able to forensically acquire volatile data in a very simple and robust manner. While it is true that acquiring volatile data can be conducted using Helix3™, the Helix3™ CD cannot be used covertly because a trained user must launch the selected tools from the CD. It also requires a fair amount of training and knowledge in order to obtain the data in a forensically sound manner.

There is a need to be able to acquire volatile data from computer systems that a subject has used. Examples include computer systems in an internet café or corporate environment. However, the problem is how to easily and surreptitiously recover the volatile data from such systems. This is especially true if the subject has not saved anything to the hard drive, or if they have “erased” all their activity. Add to this dilemma, a scenario in which a government agent is forced to use a covert source (also known as confidential informants) to obtain the data and the problem becomes even more difficult. The source's level of computer knowledge may be extremely limited. It may be impossible to send a lay person to collected volatile and perishable data, e.g. evidence of criminal activity, and minimize or eliminate the chances the source (or agent for that matter) might inadvertently or intentionally type the wrong command and actually destroy data?

Another issue that needs to be addressed is that while Windows has the largest market share of deployed desktop systems there are many other non-Windows platforms. Many public computer facilities such as internet cafés around the world utilize non-Windows operating systems such as Mac OS X or various Linux distributions. No single tool does exists that works across all platforms.

There are very few programs or options that are available. Helix3™ was the first inclusive utility that allowed the simple acquisition of volatile data from running systems. Helix3™ has continued to develop and mature and is updated on a regular basis. Some of the solutions that Helix3™ uses are: Incident Response Collection Report (IRCR) available at tools.phantombyte.com; Windows Forensic Toolchest (WFT) available at www.foolmoon.net/security/wft; The Forensic Server Project (FSP) available at www.windows-ir.com/fsp.html. Each of these tools has the capability to be scripted to run on Windows systems and acquire volatile data. None of them however, run covertly or are cross platform aware, i.e. they only work on Windows operating systems. There are a few other options that have some similar capabilities. These include EnCase FIM and Technology Pathways ProDiscover. However, all these options are limited. The biggest issue with these products is that in order to use them to collect volatile data, an agent program must already be installed on the system to be analyzed or must be installed prior to running. Thus these options will not work in an uncontrolled or covert environment.

Incident Response/Forensics in the corporate or governmental enterprise environment poses different challenges. Today's globally networked society is exposed to frequent cyber attacks. The threat to government, corporate and private networks is very real. In an attempt to mitigate the external threat, networks are defended through layered defenses consisting of Intrusion Detection Systems (IDS), firewalls, anti-virus/malicious logic applications and Intrusion Prevention Systems (IPS). Layered network defenses are effective against external threats. However, layered defenses offer little in terms of mitigating the insider threat and in the case of a breach, streamlined incident response.

Management or operations of large enterprise networks typically takes place at a remote consolidated facility. This central Network Operations and Security Center (NOSC) is the focal point for management of system outages and incident response. Responding to system outages is usually a well established and predictable process. In global networks, incident response is not predictable and at best, challenging. Incident response is triggered for various reasons. Commonly, a network defense analyst will respond to an alert raised by a network defense sensor, intrusion detection system or anti-virus application. The analyst then directs a field technician at the affected site to take investigative action. These initial actions will likely consist of running special software to reveal known hacker files or applications. More often than not, however, field technicians are not skilled in analyzing the results of the forensic application and must then forward the results to the network defense analyst. If the network defense analyst concludes the initial findings warrant further data from the affected workstation, the field technician is contacted again and retrieves the data requested by the analyst. This cycle repeats until the issue is resolved. Resolving incidents in this manner can take days to complete. Unlike other forensic investigations, computer crimes take fractions of a second to commit, and the volatile forensic evidence is available for a finite period of time.

In today's network operational environment, the time to investigate and resolve suspect activity is excessive. Time is the enemy during incident response. The entire enterprise network and supported missions remain in a highly vulnerable state until the incident is fully investigated and the method of exploitation (if any) is revealed.

Electronic discovery for litigation is another area of need. The Federal Rules of Civil Procedure provide regulations regarding how organizations should gather and prepare electronic evidence. However, there are very few standards that organizations can turn to when collecting and preserving evidence. Currently, organizations use in house procedures to collect and preserve electronic information. Once collected, the information is then provided to a service provider for processing. The service provider then uses specialized methods and tools to extract the desired information from the media and prepare it for review by internal and external counsel. The attorneys manually review the information and eliminate non-pertinent documents.

The greatest expense in electronic discovery results from: (1) the amount of information organizations collect and provide to service providers for processing, and (2) the amount of time attorneys spend reviewing and eliminating documents of no value to the case. More often than not, organizations do not have the resources or technology available to quickly eliminate redundant or non-pertinent information from a dataset. Organizations lacking an organic data reduction capability are at the mercy of businesses who provide (expensive) data reduction processing services. Organizations are typically faced with processing fees approaching or exceeding as much as $2,500 per gigabyte. Another drawback to outsourcing data reduction is the time involved with locating a service provider and the in addition to the time to process the data. This lessens the time in-house counsel has to prepare case strategies.

Today, there exist multiple software options for incident response, security and e-discovery on an enterprise level. In most cases, they are expensive, difficult to integrate into an enterprise operation, problematic and fail to focus on insider threats, anomaly detection or e-discovery.

### SUMMARY

A preferred embodiment is an automated system that can be used by government and corporate investigators (or their assets) to acquire volatile evidence from an individual's computer activity. The data may be acquired overtly or covertly. In preferred embodiments, applications of the system will attempt to avoid antivirus and intrusion detection systems, and will safeguard the collected data using encryption and/or masking techniques. In preferred embodiments, the applications and/or acquired data can only be recovered using computer forensic techniques.

In preferred embodiments, the system includes an application that permits persons that are not trained in computer forensics to locate, decrypt, document and validate the collected data in a manner that ensures admissibility in court if needed. The system can be designed to be used by law enforcement and intelligence officers and agents and adapted to the respective roles and responsibilities of such persons.

Accordingly, a method for collecting volatile data from an active target computer can comprise selecting one or more computer forensic data items for including at least one volatile data item for collection from an active target computer from among a plurality of computer forensic data items. The method then comprises generating integrated executable runtime code that, once activated on an active target computer, is capable of launching a defined sequence of data collection modules for collecting the selected computer forensic data items on an active target computer from a removable storage device without user input. The executable runtime code is stored on an initialized removable storage device. The removable storage device can then be connected to an active target computer. The executable runtime code may be automatically or manually activated whereupon the defined sequence of data collection modules is launched thereby collecting the selected computer forensic data items from the active target computer.

In preferred embodiments, the removable storage device is a USB flash drive. The drive can be a U3 flash drive comprising a read-only partition, in which case the device can be programmed by writing to the writable partition and/or the read-only partition.

In preferred embodiments of the method, the data is collected covertly. This can be accomplished by displaying a camouflaged view to the user while the data is being collected, for example a view selected from among a web browser, a card game, and an image browser, or the executable runtime code may not display any window to the user. Alternatively the user may choose overt data collection, in which case a window may be displayed reporting the status of data collection.

In some embodiments of this method, the executable runtime code is activated automatically upon connection of the removable storage device to the active target computer. Preferably, the runtime code is generated so that at the time that it is activated, a user can cause command the runtime code to either store the data items to be collected on the removable storage medium or securely transmit the data items to an internet drop site. When the collected data is stored on the removable device, the collected data items can be stored on in an encrypted database that is recoverably deleted prior to deactivation and removal of the removable storage medium from the target computer.

In an alternative embodiment, a system may comprise software agents pre-deployed on networked host computers, each agent being in communication with a server. The servers can be deployed in a tiered network comprising supervisory servers. The agents can be accessed by console administrative tools in communication with the servers. The system permits the user of the console to command the agents, through the servers, to collect forensic data from the software agents or access historical data stored on the servers. In this way, the system provides the ability, among other things, to covertly collect volatile computer forensic data from host computers, to build a case file recording activity over time, to search an entire network for evidence of malicious usage or malicious software, or to collect all data meeting specified criteria.

A system for collecting and managing data relating to the activity of a user of a networked host computer can comprise a plurality of software agents active on host computer systems, one or more servers in network communication with one or more of the software agents and one or more console administrative tools residing on computer systems capable of network communication with the servers. The software agents each comprise means for covertly and forensically collecting volatile data from the computer upon which the software agent resides and securely transmitting the data to one or more of the servers. The servers each comprise means for securely storing data received from one or more of the software agents, means for securely receiving instructions from a console administrative tool subject to an administrative permission rule, means for securely transmitting instructions to one or more agents, and means of transmitting forensic data to the console administrative tools. The console administrative tools each comprise means of securely communicating with the servers, means of requesting forensic data from the servers and from the agents through the servers, and means of verifying, analyzing and presenting forensic data received from the software agents through the servers.

### BRIEF DESCRIPTION OF THE DRAWINGS

FIG. 1 illustrates an malicious insider detection solution that implements a tiered architecture consisting of Console Administrative Tools (CAT), servers and agents.

FIG. 2 illustrates a hierarchical arrangement of supervisory servers and site level servers in which supervisory servers can be located in a global network operations and security center (NOSC) and regional NOSCs. These external supervisory servers may communicate with and collect data from one or more internal NOSC supervisory servers, each of which may communicate with and collect data from one or more site level servers, which communicate with individual software agents on a local area network. The CAT (not shown) can access the servers at any level of the hierarchy in accordance with authorizations granted by an administrator. One or more agents may be associated with each site level server.

FIG. 3 illustrates an exemplary flow chart for forensic data acquisition using a removable storage device.

FIG. 4 illustrates an exemplary flow chart for using agents.

### DETAILED DESCRIPTION OF THE PREFERRED EMBODIMENTS

Described herein are computer-based systems and methods for collecting forensic data, including volatile computer forensic data, from target computer systems in controlled and uncontrolled environments. The systems provide the ability to collect the desired forensic data covertly or overtly as circumstances may require. Although the systems and methods will be discussed with reference to various illustrated examples, these examples should not be read to limit the broader spirit and scope of the present invention. The general concepts and reach of the present invention are broader than the examples provided below.

Some portions of the description that follows are presented in terms of means, programs, and modules with a stated function that represent operations on data stored on a storage medium or in a computer memory. Such functional descriptions are used by those skilled in the computer science arts to effectively convey the substance of their work to others skilled in the art. A means, module, tool, application, or solution for accomplishing a function in a computer is here, and generally, conceived to be a self-consistent sequence of steps leading to a desired result that can be embodied in computer readable and executable instructions. A person of ordinary skill in the art will recognize that there are many different ways to embody a means for accomplishing a function in a computer that will vary depending on the particulars of the computer or computers on which the mean are intended to operate, the operating systems of those computers, the computer readable language in which the instructions accomplishing the steps are written, and the practices and preferences of an individual computer programmer. The steps require physical manipulations of physical entities. Usually, though not necessarily, these entities take the form of electrical or magnetic signals capable of being stored, transferred, combined, compared and otherwise manipulated. It has proven convenient at times, principally for reasons of common usage, to refer to these signals as data, signals, network communications, and the like. It should be borne in mind, however, that these and similar terms can be associated with appropriate physical embodiments and are merely convenient labels applied to these embodiments. Unless specifically stated otherwise, it will be appreciated that throughout the description of the present invention, use of terms such as “processing”, “computing”, “calculating”, “determining”, “displaying”, “searching”, “collecting”, “storing”, “generating” or the like, refer to the action and processes of a computer system, or similar electronic computing device, that manipulates and transforms data represented as physical (electronic) quantities within the computer system's registers, memories and data storage devices into other data similarly represented as physical quantities within the computer system memories or registers or other information storage device, transmission or display devices.

As indicated below, embodiments of the present invention are instantiated in computer software, that is, computer readable instructions, which, when executed by one or more computer processors/systems, instruct the processors/systems to perform the designated functions. Such computer software may be resident in one or more computer readable media, such as hard drives, CD-ROMs, DVD-ROMs, read-only memory, read-write memory and so on. Such software may be distributed on one or more of these media, or may be distributed across one or more computer networks (e.g., the Internet). Regardless of the format, the computer programming, rendering and processing techniques discussed herein are simply examples of the types of programming, rendering and processing techniques that may be used to implement aspects of the present invention. These examples should in no way limit the present invention, which is best understood with reference to the claims that follow this description.

The methods and systems described below provide for the forensic collection of volatile and static data from an active target computer system. Of interest because of its temporal nature, volatile data is data that is subject to being routinely deleted or altered as the system is used or in the event that the system is powered down. This includes the contents of memory whether physical, virtual, or swap, temporary files, lists of recently accessed files, internet addresses, lists of open connections, lists of attached devices, and the like. A non-limiting list of volatile data items and exemplary ways in which the data can be collected can include the following:
Internet History
   Internet Explorer—Create a summary of online activity including one or more of the following:
      Bookmarks—All pages that have been marked as a favorite or shortcut.
      History—Details on all pages visited.
      Cookies—Data items stored by web servers for future reference.
      Downloads—URL and file name of files that have been downloaded.
   Firefox—Create a summary of online activity including one or more of the following:
      Bookmarks—All pages that have been marked as a favorite or shortcut.
      History—Details on all pages visited.
      Cookies—Data items stored by web servers for future reference.
      Downloads—URL and file name of files that have been downloaded.
      Auto fill—Data strings used to auto complete forms, this includes addresses and often purchasing information used for online purchases.
   Apple Safari—Create a summary of online activity including one or more of the following:
      Bookmarks—All pages that have been marked as a favorite or shortcut.
      History—Details on all pages visited.
      Cookies—Data items stored by web servers for future reference.
      Downloads—URL and file name of files that have been downloaded.
Chat Logs
   Skype—Create a summary of online activity including one or more of the following:
      VoIP calls, including the name or phone number.
      Instant messages including the name of the third party, content of the message, and the date and time of the message.
      SMS messages, including the phone number of the third party, and content of the message.
      File Transfers.
      Buddy list and details including addresses imported from other systems by Skype.
System Passwords
   NTLM and Lan Man Password Grabber—Output the LM and NTLM password hashes of local user accounts from the Security Account Manager (SAM).
   Apple Key chain Extractor—All passwords stored in the key chain can be extracted.
Network Information
   Analysis of the network activity on the agent computer. This information includes Address Resolution Protocol (ARP) tables, network interfaces, routing tables, and network connections/statistical activity.
   ARP converts an Internet Protocol (IP) address to its corresponding physical network address. ARP is a low-level network protocol, operating at Layer 2 of the OSI model. The ARP table shows what computers were connected to a machine on the local network.
   Interface tables describe what interfaces are in use on the system and what the individual MAC address is for each of them. The Media Access Control (MAC) address is a quasi-unique identifier assigned to most network adapters or network interface cards (NICs) by the manufacturer for identification. If assigned by the manufacturer, a MAC address usually encodes the manufacturer's registered identification number.
   The routing table is a set of rules, often viewed in table format, that is used to determine where data packets traveling over an Internet Protocol (IP) network will be directed. All IP-enabled devices, including routers and switches, use routing tables.
   Network statistics and connection is similar to NetStat which displays network connections (both incoming and outgoing), and a number of network interface statistics. The processes and executable paths associated to each connection are also shown.
      Memory
   Clipboard—Capture any text contents, graphics, or binary data such as files found in the clipboard.
   RAM searching & collection—forensically acquire RAM from all platforms as well as the ability to search and preview the contents of what is in RAM prior to acquisition.
   Disk Image
   Forensically acquire physical and logical disks which are court acceptable world wide. The images allow for compression as well as size segmentation.
   Environment Variables
System Information—Create a profile of the hardware in use including (but is not limited to) the following;
   User Name
   Computer Name
   Operating System
   System Serial number
   Processor
   Model
   UUID
   Time Zone
   Country Code
   OS Registration Information
   Installed Drivers
   Volume (Drive) Information
Process Information
   Processes—Analysis of all running processes on the system to include the full executable path information, memory usage and associated dynamic library files.
   Services—Analysis of all system services to include ones that are running or stopped.
Registry Information
   Extract all settings from the Windows registry which is a directory that stores settings and options for the operating system for Microsoft Windows 32-bit versions, 64-bit versions, and Windows Mobile.
System Logs
Extract the system, application, and security logs from Microsoft Windows systems.
Active Data
   Screen shot—Capture and save a screen shot of the main screen on the system.
   KeyLogger—Capture all keystrokes and show both the raw and converted versions.

It is the responsibility of the investigator to ensure the completeness, integrity and accuracy of the data in the evidence acquisition process. Three principles of computer forensics that are advantageously taken into consideration in a system for acquiring data as follows: Reconnaissance, Reliability and Relevancy. Reconnaissance is the principle that an investigator collects as much evidence as possible. This is applied in the acquisition phase. The principle of reliability applies to the storage phase is where the data needs to be preserved in an optimum format to preserve evidentiary value and verifiability. The final principle is to accurately identify all of the relevant evidence. This principle is applied primarily in the analysis phase. The systems and methods described below are capable of acquiring volatile computer forensics data in a forensically sound manner.

Acquiring Computer Forensic Data in an Uncontrolled Environment.

Acquisition of volatile computer forensic data in an uncontrolled or public environment presents different challenges than acquisition of data in a corporate or enterprise environment. The trained forensic investigator may not have access to the target system, rather it may be necessary to rely upon an untrained agent such as an informant, cooperating witness, or intelligence asset. Therefore, it is advantageous to divide the procedure into phases, wherein the data acquisition phase can be carried out overtly or covertly by a person who has little or no training, but who does have physical access to an active target system.

In an embodiment of the system and methods described herein, a computer forensics data acquisition system and method is provided in which a customized selection of computer forensics data items can be chosen from a list presented by console software running on a computer. Runtime code comprising modules for collecting the selected data items is then generated by the console software and packaged in one or more integrated applications that can be executed from a removable storage device, preferably without causing any persistent change to the target computer. The executable runtime code is then loaded onto a removable storage device. The programmed device is then connected to an active target system, and the executable runtime code is activated. The executable runtime code can launch the modules for collecting the selected computer forensics items in a defined sequence without further user input. Collection may be performed covertly or overtly. Following completion of the data collection, the programmed device can be inactivated and removed from the target system. In a preferred embodiment, the device is returned to the computer running the console software for recovery and analysis of the collected data items.

The system comprises system management console software running on a computer programmed with system management console software and a removable storage device. The management console software comprises code for a collection of computer forensics modules, each module being capable of collecting a forensic data item from a target computer. The management console software permits the user to select a customized set of data items, preferably including at least one item of volatile forensic data from a list of the available modules. The management console software also comprises a module to generate runtime code that can launch modules for collecting the selected items on an active target computer from a removable storage device. The management console software comprises a module to program the removable storage device with the package of runtime code. Thus, after the device is programmed, the system also comprises a removable storage device comprising a custom generated package of runtime code for collecting the selected set of data items. The management console software can also comprise modules for recovery and analysis of data collected by the computer forensics modules. However, in some embodiments, for example where the data collection modules used are standard tools, the data may be recovered and analyzed on a separate system. In other embodiments, the data may be stored such that it can only be recovered by the management console software that generated the runtime code for the device.

In preferred embodiments of the method, the data is collected covertly. This can be accomplished by displaying a camouflaged view to the user while the data is being collected, for example a view selected from among a web browser, a card game, and an image browser, or the executable runtime code may not display any window to the user. Alternatively the user may choose overt data collection, in which case a window may be displayed reporting the status of data collection.

The active target computer in the above method can be a public computer in a library, hotel, internet café, school, and the like, or may be a personal computer left running unattended in a home or business and the like. The target computer can be any computer that has recently been used by a subject under investigation, preferably a computer in which the subject has not shutdown or restarted the system after use.

Volatile data refers to data created during the use of a computer that is subject to being erased, overwritten, or lost with further use or upon powering down or restarting the system. Volatile data includes the contents of RAM, memory caches, CPU state data, CPU cache, temporary files created by active applications such as web caches, cookies, bookmarks, swap files, windows registry contents, lists of recently accessed files and internet pages, contents of the “recycle bin” or “trash can,” data on active applications and network connections. Thus, in accordance with the requirements of a particular job, volatile data that can be collected by the various modules include: date; time, volatile memory from physical memory; volatile memory from pagefile and swap drive; volatile memory from virtual memory; network connection data, lists of open TCP or UDP ports, NetBIOS, neighboring network connection information; currently logged on user, user accounts; current executing processes, services; scheduled jobs; open files and registry database; browser auto-completion data, passwords; screen capture; chat logs from program like Skype, AOL, Yahoo; SAM password files, and the like. A trained user selects a set of forensics data to be collected as required for a particular job.

The plurality of computer forensics modules comprised in the management console software may include the tools found on the Helix3™ CD. The Helix3™ CD contains a comprehensive set of tools and a GUI interface for launching the tools. However, the Helix3™ CD, or the like, is not suitable for use as the removable storage device in the above method, because the Helix3™ CD does not contain runtime code capable of launching a selected set of tools in a defined sequence on an active target computer from a removable storage device without user input. Use of the Helix3™ CD requires substantial expertise, and cannot be used in a covert manner. In a preferred embodiment, unlike the tools on the Helix3™ CD, the plurality of computer forensics modules comprised in the management console software includes modules that have been written so as not to rely upon any native operating system API calls. The data collection modules can utilize low level code allowing the modules to avoid detection by anti-virus or computer intrusion detection systems and may also avoid causing any persistent change in the host computer. In addition, it must be recognized that Windows Vista and XP service Pack 3 changed the way in which an individual can acquire the physical memory. In order to acquire the physical memory from a Vista computer running on Vista, a special device driver is preferably used to access the kernel space where the memory resides.

The system and methods described above can be designed so that collecting volatile data from the active target computer may require simply connecting the removable storage device to an active target computer. Alternatively, the system and method may be configured to utilize a launcher such as found on U3 enabled USB flash devices to allow the user to activate the runtime code with a single action. The executable runtime code may then proceed to collect the data without further user input. The selected data forensic data collection modules are launched in a defined sequence upon activation of the runtime code so that data collection can be carried out in a covert manner.

The executable runtime code prepared by the management console software can comprise one or more executable files prepared in the form of one or more portable applications and optionally script files for launching the tools. A collection utility can be created to acquire volatile data, using known binary code comprising a plurality of computer forensic tools, with no or minimal alteration of the original data. In a preferred embodiment, one or more integrated applications is created for launching the data collection modules. Each integrated application can contain a set of collection modules for collecting a selected set of data items and optionally code permitting the application to masquerade as a commonly used application. Preferably, the entire procedure is a non-intrusive evidence extraction process. No software will be installed on the target (suspect) machine. Preferably, there will be very little or no forensic footprint left behind.

A portable application is a computer software program that does not need to be installed or copied onto a computer's hard drive to be executed, running instead from a removable storage device such as a CD-ROM drive, USB flash drive, flash card, or floppy disk. Portable applications can be run on any computer system with which they are compatible. Portable software is usually designed to be able to store its configuration information and data on the storage media containing its program files. Thus, portable applications preferably leave the computer they run on exactly as they found it when finished. This means that the application preferably does not use the registry, nor store its files anywhere on the machine other than in the application's installation directory. Preferably, the integrated runtime code applications do not require any separate configuration files.

A removable storage device is generally a computer device that can be irremovably connected to or inserted into an active target system. The removable storage device is capable of storing runtime code for execution on the target system. The removable storage device is preferably a commonly available USB flash memory device (USB key), most preferably a U3 enabled USB flash drive (U3 key). U3 keys are USB flash drives with a specific hardware and software setup. The hardware configuration causes Windows disk management to show two drives, a read-only ISO 9660 volume on an emulated CD-ROM drive with an autorun configuration to execute a U3 LaunchPad, and a standard flash drive that includes a hidden “SYSTEM” folder with installed applications. The preinstalled U3 LaunchPad can be replaced so that tools installed on the device can be launched upon connection of the U3 drive without user intervention.

Other types of removable storage devices may be used in the system. For example, many cellular telephones, digital music players, digital cameras, and the like contain USB, firewire, or e-SATA connectors and behave in a manner analogous to a USB key when connected to an active system. Likewise, removable memory cards for such devices can contain USB connectors or be inserted into card readers that may be built-in or removably connected to a target system.

The executable runtime code is capable of launching the data collection modules in a defined sequence on an active target computer from a removable storage device without user input. The proper execution order for the defined sequence is preferably arranged to minimize possible fault or errors as the program modules are executed on a target computer. For example, the launching of tools executed from the removable storage medium can be arranged to be completed in order of volatility. The agent who connects the removable storage device to the target computer may be required to activate the executable runtime code if the target computer is configured to prevent the automatic launching of programs upon connection of a storage device. Alternatively, upon connection of the device, the agent may be presented with a standard launch menu such as provided on a U3 enabled device. However, advantageously, the activated executable runtime code will not require further action on the part of the agent to launch the data collection modules in a sequence that has been defined by the management console software when the executable runtime code was generated. In preferred embodiments, the executable runtime code is activated automatically upon connection of the removable storage device to the active target system.

Storing the executable runtime code on an initialized removable storage device is carried out by the management console software. Initialization may be carried out by the management console software or the removable storage may be initialized prior to use. Initialization can comprise forensically cleaning and preparing the removable storage media device for use. The executable runtime code may comprise a single integrated application or may comprise a launcher and separate modules. This code, together with any files required for automatic launching, for example a “autorun.inf” file for use in a Windows environment, are stored on an initialized removable storage device according to the requirements of the code and the device. For example, U3 USB keys have particular partitioning and file system requirements.

Connecting the removable storage device to an active target computer can comprise inserting a storage device into the appropriate receptacle on the target system. For example, the connector of a USB key is inserted into an unoccupied USB port. Flash memory cards can be inserted into onboard card reader slots or into a card reader connected to a USB port. Other flash memory devices, such as music players, cameras, telephones, may require a connection cable. Removable hard disk drives can comprise built-in connectors or may require an appropriate cable. Optical storage devices may be inserted into internal optical drives or into external readers connected by cable.

Once the executable runtime code has been activated, collecting volatile data from the active target computer in a covert manner is carried out by the data collection modules and will not require further action on the part of the agent. In a covert manner means that the launching of the data collection modules will not be apparent to an observer. The executable runtime code may be programmed to cause no change in the display of the target system. This may be accomplished in a launcher by activating a hidden menu and causing the application window to open off-screen. Alternatively, the executable runtime code may be programmed to present a camouflaged display giving the appearance that the agent is engaged in an innocuous activity such as web browsing, playing a card game, browsing image thumbnails, and the like. The executable runtime code may be programmed to covertly signal the agent that the collection has been completed through a change in the camouflaged display or by some other visual or audio cue.

The method can comprise storing the collected data on the removable storage device for analysis. In this case, the storage device cannot be an entirely read-only device. Upon completion of data collection the removable storage device is deactivated and removed. Prior to deactivation, the file containing the stored results may be marked as deleted in the file system of the removable media so that its presence will not be apparent if the device is examined. When the removable device is a USB flash memory device such as a thumb drive, it may comprises a writeable partition and a read-only partition, the runtime code can be stored on the read-only portion to prevent tampering or accidental destruction and the results of data collection can be stored back to the writable portion. Thus, in a preferred embodiment, storing the executable runtime code and tools on an initialized removable storage device comprises programming the read-only portion of the thumb drive. Such an embodiment can be carried out with a USB thumb drive programmed using U3 technology.

More generally, the system can be considered to have three elements. The first element is a management interface which manages and controls the modules/programs that can be utilized in a live environment. The modules/programs may comprise tools that have been proven and tested by use in the forensics community or the modules/programs may comprise custom tools that utilize unique methodologies, such as not relying on any native operating system calls. The second element is the runtime executable code that is generated by the management interface and is stored onto a removable storage medium such as an industry standard USB key. The third element is an analysis and reporting capability.

Thus, as a first element, the system includes a management console that any trained user can easily use to create runtime code for a specific job. The console can be designed to be used in the field by agents or assets with little to no training. The management console can be setup on a system such that a trained user can select from a series of data items to collect on a particular operation and the manner in which the data is to be collected.

As a second element, the system will setup and generate executable runtime code to launch the tools in proper forensics execution order once the user chooses the tools for that particular operation. The system may automatically place the code on an initialized USB drive or other removable storage medium. That programmed device can be given to any agent to connect to the target system, e.g by inserting a programmed USB key into a port on the target system. Once the drive is inserted, the runtime code may be automatically activated or the agent may activate the runtime code to collect the volatile data with no further user interaction required.

The data may be securely stored back to the programmed removable storage media or transmitted to a secure drop site on the internet. Once all the forensic tools have finished collecting data, the executable code may surreptitiously signal the agent, who can simply remove the storage medium and returns it to the handler where analysis can be performed. An advantageous aspect of the system is in the generation of the runtime executable that will run from the removable storage media. Preferably the system is written in a cross platform capable language so as to be portable across Windows, UNIX, and Macintosh systems. Runtime executable code for programming a removable storage medium can be written so as to run on a computer under each operating system.

The third element provides an analysis and reporting capability. The management tool can generate runtime code to collect data in a forensically sound manner so as to verify the integrity of the evidence after analysis.

Generally, methods of using the system may be separated into three primary phases. The first is in the device preparation. The second is in the forensics acquisition and the third is the forensics analysis.

Device Preparation Phase: A user such as an agent's handler will preferably first be trained in the use of the system to fully understand its power and use. That individual would be able to initialize a removable storage media device such as a USB key. The user can select the appropriate data items for each specific case requirement. Upon selecting the appropriate data items, the management console software can automatically generate executable instructions, which may be in the form of one or more runtime executable files and optionally additional script files that would then be placed onto an initialized USB key. The system comprises all of the modules/scripts and the like that the system needs in order to generate the executable instructions. Once the runtime code has been placed onto the removable storage media device by the management console, the device can be turned over to an agent. The agent would require very little instruction in the use of the system, the device, or the runtime executable instructions.

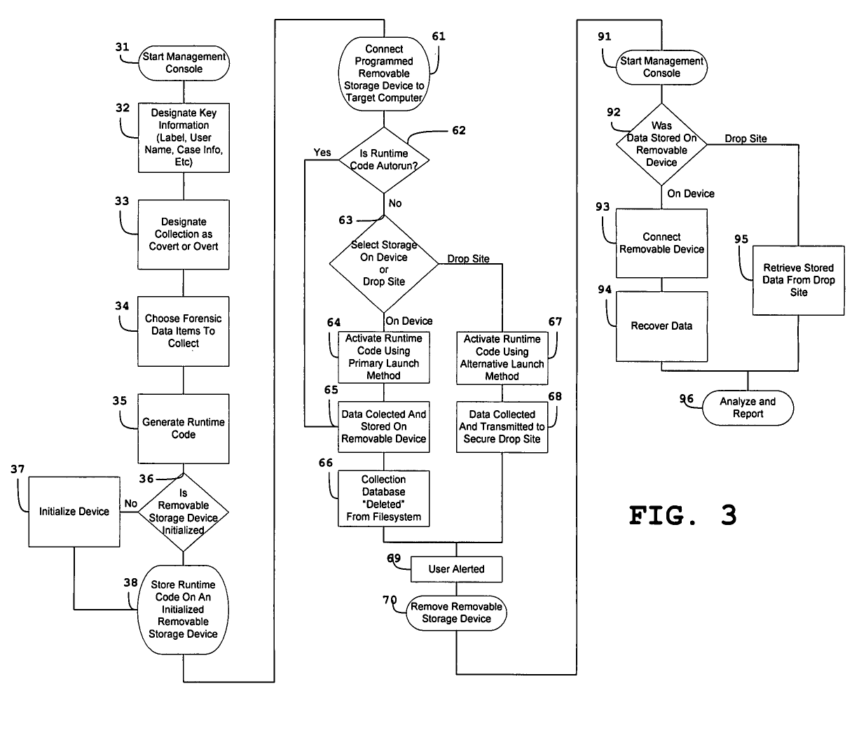

Thus, referring to the first column of FIG. 3, a flow chart illustrates a method of using the system. A trained user starting the management console 31 is provided with the opportunity to select key information, for example a label for the removable storage device to be used, case name, user information, and the like. The user can select 33 whether the system should generate code for covert or overt data collection. The user can select 34 the data items to be collected. The system will then generate 35 the runtime code for that job. If an initialized removable storage device is not already prepared, the system can initialize a device. The runtime code is then stored to an initialized removable storage device.

Data Acquisition Phase: This phase, while simplistic in use, can be the most complicated to perform. Executable instructions will have been stored onto a USB thumb drive that was prepared in phase one. In addition to the secure modules and the executable launch instructions, a portable application program can also be stored on the removable storage media. The code can be configured to perform various activities while collecting the data. The time it takes to run the executable instruction set depends on which data items were selected during the generation phase in the management console. Preferably, each data collection module has been tested and an average execution time has been calculated so that a rough estimate of the total runtime will be displayed in the management console, i.e. during selection and before the runtime code is generated. The most significant variable in calculating the runtime is the amount of memory on the system being acquired.

In a preferred embodiment, the runtime code stores the collected data by writing each item collected into an encrypted database, which segregates the collected data by machine and collected item as well as by date and time. Once all the data has been collected the database is removed from the file system by deleting it. The database can be recovered using forensics techniques or by the console software. However, in a preferred embodiment, only the console software can reconstitute the deleted database and recover the data within it. For example, the database may be encrypted using a secure encryption key (e.g. an AES 256 bit key) which only the console software has. When the data is stored in this way, the key will appear to have the same files and size before and after an acquisition. This makes the key seem to be the same before and after a collection has occurred.

Thus, referring to the second column of FIG. 3, a flow chart illustrates an exemplary method of performing data acquisition using the system. The device that was prepared in the first phase is connected 61 to the target computer. If the runtime code has been generated to be autorun 62, and the computer does not have autorun disabled, then the data collection will begin immediately. Alternatively, the user may be presented with a launch menu. The user may be required to navigate the directory structure of the removable storage device and activate the runtime code directly or activate the launch menu if autorun is disabled on the target computer. At the launch menu, the user may have the ability to select whether the collected data should be stored on the removable storage device or transmitted over a network to a secure drop site. This may be accomplished covertly by using either a standard launch method 64 (e.g. left click on a runtime executable) or an alternative launch method 67 (e.g. shift click, right click, or the like). Following runtime activation, then the collection begins and proceeds without further intervention. If storage on the device was selected, then the results may be stored 65 in an encrypted database on the device. To hide the collected data, the database can recoverably “deleted” from the files system of the removable storage device. If transmission to a drop site was selected, then the data is collected and securely transmitted 68. Upon completion, the user is alerted 69 so that the device can be removed 70.

Report Generation Phase: Referring to the third column of FIG. 3, a flowchart illustrates an exemplary sequence of steps for a report generation phase. After collection of the volatile information from the target machine, investigators can take the removable storage device and re-insert the device into the machine running the system management console for report generation 91. The “deleted” database is recovered and decrypted. Data transmitted to a secure internet location can be accessed and downloaded into the machine running the management console 95. Thus, however the data has been collected, the data can easily be recovered at a later time by the handler using the system management console. The console software comprises modules for analyzing and presenting the collected data 96.

The system is designed for the law enforcement and intelligence community to acquire volatile data on machines they would not normally have easy accesses to without drawing attention. It is suitable for covert operations, especially undercover operations. However, there may just as well be corporate uses as well. Computers are now involved in almost every type of serious crime. Typically, the technology the law enforcement and intelligence committees need to keep up with the threat has lagged behind the capabilities that criminals and terrorists have at their disposal to plan and execute their activities. These adversaries have long used public computers to communicate with each other with little to no fear of their activities being discovered. This system, in the hands of a skilled user, can level the high tech playing field. No longer will internet cafe's be considered a communication “safe haven.” With this system, those little scraps of perishable evidence that are typically ignored or not known about might make the difference in the war on terror and general crime.

Acquiring Volatile Computer Forensic Data in a Controlled Environment.

When the environment in which forensics data is to be collected can be controlled, such as in a corporate enterprise environment, data may be collected by software agents deployed on target machines. Such a system may be capable of assisting first responders and network defense analysts in rapid and accurate assessment of suspicious workstation or network activity. This solution can provide network administrators and security personnel with mechanisms to effectively counter threats posed by insiders to the security and integrity of the corporate networks and the data contained therein. In addition to the incident response capability this system can use the power of the network to assist in e-discovery. When set up to have access to the entire network strata the system can quickly and efficiently locate responsive data to a litigation hold request.

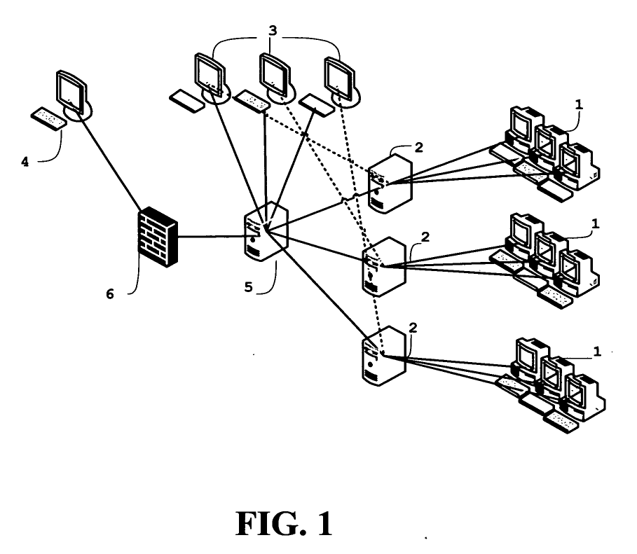

Insider Detection/Surveillance: Identification of insider activity requires forensically sound and robust data harvesting techniques. System events and activity offer vital clues to detect insider activities such as permission elevation, covert data tunnels, and data exfiltration. An enterprise system for surveillance and detection of insider activity can be comprised of software agents, servers, and console administration tools (CATs). A schematic of an exemplary network design is illustrated in FIG. 1. Software agents are deployed on individual workstations 1. These agents are connected by network to servers 2. CATs 3, 4 communicate with the agents via the servers. The servers may be arranged in a hierarchy with regional servers 5 communicating with local servers 2 that are networked directly to the agents 1. The CATs 3,4 may be connected directly to the local network 3 or may access the agents remotely 4. CATs can access the agents through the servers. Preferably, each component is a 32-bit application compiled for Windows Servers, Win 2000, Win XP and Microsoft Vista platforms. The CAT also preferably supports Linux and Mac OS X platforms.

Software Agents: A remote software agent can monitor, collect and search the volatile and non-volatile data present on a host computer. This comprehensive data collection capability allows administrators or analysts to rapidly determine the nature of suspect activity. These remote forensic capabilities include, but are not limited to the collection and retrieval of any volatile data,.user information, network information and associated processes, screen captures and remote forensic disk and RAM imaging.

Agents may be pre-deployed using any existing software deployment or patch management solution. System servers may comprise modules that are capable of deploying agents to host computers. Preferably, the server deployment module is capable of interfacing with existing software deployment solutions. Agents and configuration files can masquerade as routine system patches for deployment. The agents stand ready to provide information network defense analysts need to rapidly assess suspicious network activity. In some circumstances, it may be desirable to run an agent on a machine which does not have an active agent. In this case, an agent may be run from a live CD. Such a CD may also be used to deploy an agent. The information provided by the agent can include often overlooked volatile data. The active agent preferably masquerades as a routine process on the workstation and does not interact with the user. The agent produces no visual evidence of its existence. That is, no icons are displayed in the system tray or tool areas of the workstation. Preferably, the agent only accepts commands from a designated CAT (through a server) via encrypted TCP communication. The agent can be configured to beacon at workstation start so that servers may maintain a list of active agents. The beacon can also updates the CAT display to reflect the node's status on the network. Through the configuration utility located on the CAT, the analyst can configure the agent to beacon at any desired interval. In addition, the CAT operator can direct each agent to “beacon” on demand.

The agent may be designed to operate on Windows 2K, XP, Vista, and Windows Servers as well as OS X and Linux platforms. Preferably, the agent does not interfere with the operation of anti-virus engines or other malicious logic detection applications. An agent monitor may reside on workstations and servers together with an agent to restart non-responsive agents. However, this arrangement is not required.

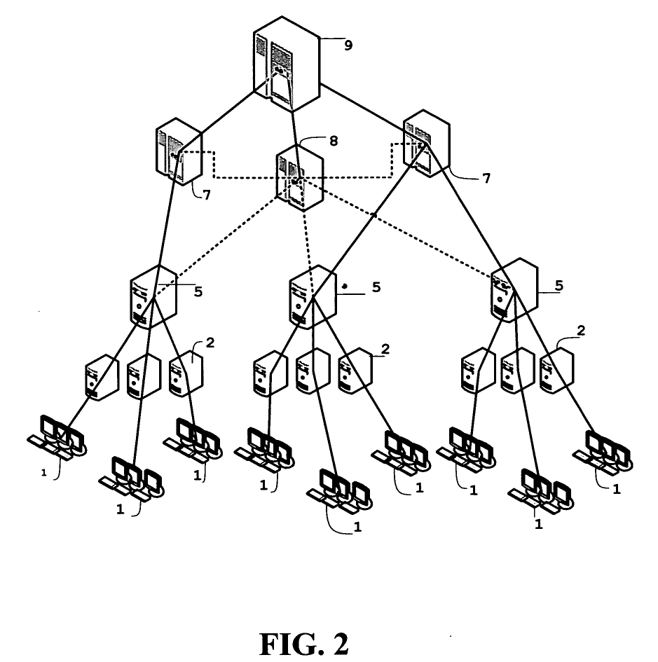

Server Hierarchy: The server component can serve two major purposes. The server can pass requests from the CAT to the agent. The server can store data created by the agents for later access by a CAT. As illustrated in FIG. 2, the system can be deployed with a hierarchical server arrangement on a global network. Site level servers 2 at each location communicate with and collect data from agents deployed on local workstations 1. Network operations and security centers (NSOCs) at each site comprise supervisory servers 5 that communicate with and collect data from site level servers 2. Above these, regional NSOCs 7 can be deployed to monitor and collect data from supervisory servers. A global NSOC 9 may comprise a supervisory server for monitoring all activity throughout the enterprise. The system may comprise one or more failover sites 8 in different cities.

The Console Administration Tool: The CAT is the focal point for agent command and control. The CAT may be deployed within a local area network or may access the system servers from anywhere on the internet. Communication between CAT and server can be encryptions with DOD and NSA approved encryption methods such as the 256-bit AES standard.

Through the server, the CAT manages agents within an internal network or distributed across a global enterprise. An authorized user can log in to any server on a network using the CAT. The CAT provides a comprehensive view and operation of network workstations hosting agents while limiting access to only those groups of agents approved by the server administrator. This ensures that CAT operators (analysts) access only those agents within their respective areas of responsibilities. The CAT GUI can be divided into many areas, with each presenting different granular data views.

Preferably, the CAT implements an intuitive “point and click” interface for system operation and configuration. The CAT can be designed to require minimal training for effective configuration and operation. The simple interface relieves the owner of costly training, allows users to get up-to-speed in minimal time, and eliminates prolonged integration into an operational environment.

The CAT can be a stand-alone device that does not interfere with the management, distribution or installation of software patch management solutions. A first component of the CAT interface is a hierarchical list view of all network nodes. An analyst or administrator can have the capability to assign IP ranges or nodes into logical groups. This capability provides analysts or administrators the flexibility to group nodes into entities that reflect the structure of the organization.

The analyst can interact with each node in the hierarchical list simply by activating a node or group icon to present a menu of data items the agent can return to the CAT via the server. These items include but are not limited to: Operating System Information; User Account Information; Volume (hard disk) Configuration; Host Name; Clipboard Contents; System Uptime; Screen Capture; Key Stroke Log; Network Packet Capture; Network Configuration; Running Service/Processes Information, Registry Information; Event Logs, Internet Browser History queries and alerts upon insertion of removable storage media. System and RAM imaging may also be available. On demand through the CAT or in accordance with pre-configured options, each agent provides real-time remote access to volatile and other pertinent data. All of this information is date/time stamped using GMT/UTC and is obtainable either at workstation startup, on an analyst defined schedule, or in real time via the CAT. Logged agent activity is also configurable by the analyst or administrator. The system may be configured to provide an analyst with an alert upon detection of suspicious activity. The system can be configured to reduce data by eliminating duplicate data.

Each requested data item can be acquired by a routine that is a custom part of the agent without relying on any system code native to the target system. Data retrieval can be accomplished via custom Application Program Interface (API) calls. This means that preferably, no native operating system commands on the system are executed. This approach mitigates the threat posed from native commands contaminated by malicious logic (rootkits). Data integrity can be maintained by a variety of means. The analyst may be prevented from changing the contents of any log file. System administrators can limit each user's access to specific categories of data. Workstation agents may be assigned security levels to which an analyst permissions may be limited. Access may be restricted to agents in specific locations or according to areas of responsibility, e.g. accounting, personnel, R&D, and the like.

All user activity on the agents and CATs is preferably archived to an audit log. The CATs and agents preferably implement a mechanism to uniquely identify the agent and CATs to facilitate auditing. Another major area in the CAT interface is the audit history window. This window displays a current view of each node's audit history. The data displayed in the history window is contained in the server database. The window refreshes each time a new node is selected on the hierarchical list. This provides the analyst a quick view of the node's audit history and includes the nodes IP address at the time, Start and Stop Time, the User responsible for executing the Audit, and the returned audit items. Audit notes can be added to any audit for either case activity or future reference. Only audits with notes will display the note icon. In addition it is very simple to rename an audit to something descriptive for the analyst. Another major area of the CAT's interface is the Recovered Results Window. This area presents the audit information associated to the linked audit list box.

The CAT contains an Options window to adjust the agents' configuration. The purpose of the configuration file is to establish critical communication settings. Additionally, the configuration utility provides the analyst the flexibility to configure each Agent to return specified data to the CAT at workstation boot. For example; if the analyst is monitoring a specific user, the utility can generate an Agent configuration file to start key logging and packet capture at the suspect's terminal at system boot.

All network communication between CATs, servers, and agents is preferably encrypted. One suitable encryption method is the 256-bit Advanced Encryption Standard (AES). Information stored within the system database is protected using 256-bit AES encryption. The Advanced Encryption Standard (AES) is a Federal Information Processing Standards (FIPS) approved cryptographic algorithm for use in protecting electronic data.

Agent Incident Response: When an incident occurs or anomalous activity is suspected, the analyst operating the CAT can query one, some, or all terminals for desired information. During an investigation, the investigator uses the CAT to send the agent a request for information. The agent uses this message as input to generate and return the information requested. The commands collect and return the information needed for timely incident response. For example, should a node on the internal network be suspected of communicating to a known hostile site, the CAT can establish an encrypted link with the agent and command the agent to return the suspect node's internet history, listening ports, screen captures and running processes and login of current user. In the case of suspected malicious activity on the workstation, the agent can be configured to collect and return the user's keystrokes and screen captures.

Data Format and Storage: Upon receiving a command from the CAT, the agent executes the command(s) and prepares the data for transmission. Preferably, the agent converts the data to XML format. Once in XML format, the data is then encrypted with 256-bit AES encryption and stored in the H3E server.

Agent Data Integrity: The agent preferably does not rely on native operating system commands to retrieve information. The agent implements custom written API calls to retrieve accurate information. This mitigates the threat from using native commands replaced or altered by malicious logic. All Agent command activity is archived to an internal audit log. This log is protected via 256-bit AES encryption. In addition, all data is encrypted and time stamped using GMT/UTC.

Network Traffic: The amount of network traffic generated by the agent is preferably minimal and highly configurable. The data can be returned on a scheduled basis or on demand. The returned data preferably consists of text files containing XML formatted data. These files preferably average approximately 3 KB in size. Screen captures are slightly larger (on average these can be approximately 100 KB). Screen captures can be executed on demand or according to a schedule. The CATs can control network traffic saturation. That is, the analyst or administrator can control of the amount of data introduced to the network. The system may be configured to return analyst-defined data at defined intervals, for example either every minute, every hour, at workstation boot or only on demand. In this manner, it is possible to minimize the impact of the system on network traffic. In most cases, the need to adjust agent bandwidth utilization is minimal. However, the transfer of full hard disk or RAM images is an exception. Bandwidth throttling can be used when moving large files across a network.

Most enterprises focus simply on the external threat and do very little or nothing to mitigate the threat from within. Studies consistently report the greatest threat to any operation comes from within. The insider already has access to the operation (network account) and only requires a motive to exploit his access to information and operations. Given traditional network defenses, skilled inside attackers or systems compromised by professional hackers are difficult to isolate and identify. The skilled attacker will have the tools and take measures to circumvent layered defenses. Securing the network from careless users, external attackers or malicious insiders is arduous. Rapidly assessing the magnitude of a compromise is nearly impossible without a large team of incident response experts. In this day of expanding global operations and reliance on the internet, companies need to leverage technology to efficiently use the skills of their few resident experts, or contracted consultants. In other words, companies need to make the network work for them, not against them. Reliance on traditional network defense tools is a recipe for failure. Skilled criminals will bypass well known layered defenses. In the case of sensitive or proprietary data theft, skilled criminals will not exfiltrate data in an obvious manner. The data will likely be encrypted and transferred across the network, transferred via modem or a covert wireless network, or downloaded to removable media and carried out the front door. All of these scenarios easily circumvent “defense-in-depth”.

In preferred embodiments, the agents of the system can monitor activity on every workstation in the enterprise. The agents may be programmed to send an alert to the servers upon detection of any suspicious activity, including but not limited to attempted access to restricted files, changes in permission levels, anomalous user log in (a user logs in to a workstation other than her assigned workstation), opening anomalous network connections, transfers of large data sets; connection of removable storage devices; and the like.

Advantageously, the presence and activity of the agent will not be apparent to a user of the system on which it resides or to a user of the network generally. Impact upon the network can minimized by bandwidth throttling and all communications among CAT, server, and agent can be encrypted. Preferably, the agent operates covertly on the workstation or server on which it is installed. The agents preferably do not present any icons to the user, for example in a start menu, application toolbar, or the like. To be sufficiently covert, it is not necessary to hide the agent from the operating system. Rather, the agent may be hidden in plain sight. For example, the agent may masquerade as a common process in tools available to the user that list active processes and/or processes with open network connections. The agent may be designed so that if a user attempts to stop the agent process, it will restart automatically. The restarted agent may appear to have a different process name. To minimize the apparent effect on the resident system, the system resources used by an agent may be limited. For example, the agent may be limited to a designated percentage of CPU, memory, or disk resources. In one example, the agent may be set to reduce its activity if the system approaches maximum capacity, for example if CPU resource demand peaks above 90%. Preferably these limits can be configured in real time by the CAT communicating with an agent through a server. For example, in routine monitoring the frequency and amount of data retrieved by an agent may be limited so as to be unnoticeable by a user of the system on which the agent resides. However, these limits may be overridden by an analyst seeking real time data in response to an incident alert.

The system permits an analyst using a CAT to perform real-time monitoring of the complete activity of a host on which an agent resides including complete screen shots, key stroke monitoring, active process monitoring, memory imaging, file system monitoring, network connections, browser activity, and the like. The analyst can increase or eliminate resource and bandwidth limitations on an agent as required.

To reduce the use of network resources, the CAT in communication with servers can designate a limited set of data to collect. The set of data parameters to be collected may be conveniently set by selection of a pre-set recording level. For example, at a low level collected data might be limited to user log in/out, file access, and internet connection logs. At a higher level, key logging may be added, and at a higher level, screen capture images at set intervals may be added, and so on up to the highest level where a complete forensic image of the host might be collected.

To reduce the impact of agent activity on the host system and network, the agents and servers may employ de-duplicating logic. De-duplication at the agent and server levels can reduce the amount of data stored and transmitted by eliminating redundant copies of common data. De-duplication is advantageously employed during routine activity logging, but may also be advantageous in real-time monitoring to reduce the load on the host system and network.

Data reduction logic can be included in agents. For example, agents can be programmed to track memory and file access so that the CAT can instruct agents to transmit to the server only recently accessed or changed volatile data, for example RAM imaging may be limited to recently active memory addresses, registry data may be limited to recently accessed or changed keys, and so on. When routinely logging RAM or disk contents, after transmitting a complete image, an agent may transmit only subsequent changes. Alternatively, in a time sensitive incident response situation an agent can image the most recently accessed memory and files first and then proceed to retrieve the remainder of a host RAM and disk image.

Deduplication logic incorporated at the server level is also advantageously used in e-discovery. In this case, hashes of documents identified by agents can be compared at the server level so that only one copy of any document is returned in a search. Most hashing techniques are designed to identify perfect matches. Fuzzy hashing techniques can be used to identify documents that may differ in only insignificant ways. These documents may require the judgment of a reviewer to determine whether the documents are redundant. The system preferably can identify and groups such documents in order to expedite the review process. In preferred embodiments, the system is programmed to recognize the structure of formatted documents to distinguish the nature of differences. For example, the system can be programmed to determine if two e-mail records are identical except for header information, or if two word processing documents are identical except for differences in some metadata component of the file.

The CAT can access any agent on the network (subject to permission levels) through its associated server. The servers store logged data transmitted by the agents and maintain communication with agents on active systems. The analyst using the CAT can obtain and analyze live data or logged data. The system preferably provides search capabilities by keyword or unique file identifiers such as file hash codes. Thus, for example, an analyst can locate all copies of a file of interest by searching the network for files containing keywords or identifiers such as a MD5 hash. Servers may respond to search queries by referencing logged data and/or by querying agents. Proactive monitoring permits alerts to be triggered by changes to or copies made of sensitive files. Agents can be programmed to recognize events that indicate suspicious activity.

The system employs information assessment methodology which may be implemented at the server and agent level. At the agent level, events may trigger a graded level response. For example, an event may be characterized as level 1, 2, or 3 from most critical to least critical and the agent may respond by transmitting an alert to its associated server and taking other actions to increase monitoring for preservation of evidence. Likewise, at the server level, events reported from one or more agents may trigger a graded response that may involve increased monitoring at one or more agents. Supervisory, regional, and global servers may be configured to respond to events on a regional or global network basis. Any server may be configured to alert one or more analysts through active CATs or by transmitting a message via e-mail or directly to a mobile device to responsible analysts.

The increasing complexities of enterprise networks have previously presented increasing challenges, this system leverages the power of the network by connecting agents to servers, and servers to a central console. A hierarchical system of ubiquitous agents managed on local network segments by local servers, which can be managed at a higher level by supervisory servers, which can be managed by regional servers, all of which can be tied to a global network operations server permits an analyst to see network operations at any level of specificity. At each level, server logic may be trained to distinguish normal from abnormal activity. De-duplication logic applied at each level permits a reduction of inspected data to those events that are most likely to reveal a problem. At the same time, this structure permits an analyst to drill-down to a specific region, local segment, or individual host to examine logs of past activity or collect data in real time. Complete forensics data collection can be initiated immediately and covertly in response to suspicious activity. Information assessment methodology permits the system to begin to respond to events and preserve evidence at all levels immediately upon a triggering event. The ability to collect and log live volatile data remotely and without detection provides the ability to collect evidence before a subject is aware that data is being collected and without disrupting business operations.

E-Discovery: Organizations may be unaware of the potential sources of relevant documents as employees may store messages on PDAs, in personal folders on a PC or on a company file server. These document storage locations along with IT systems including messaging application servers, primary storage systems and tape archives, may have to be processed as part of a discovery request. Depending on the scope of the request, an organization may need to capture, collect and process information from all of these sources. Organizations must collect data based on custodians, keywords, a data range or a set of keywords, as defined in the discovery request. Ensuring that the results of the gathered results are consistent is extremely difficult and can often take multiple days. Once the appropriate data are identified, an organization must centralize the information to allow attorneys to begin the review and data reduction process. As with other discovery processes, the information gathering and processing must adhere to chain-of-custody mandates preserving the evidence for admission into court. It is difficult for organizations to store data in a manner that allows for simple collection of responsive data. As a result, responsive data is distributed across the entire enterprise. The distributed data requires the collection of massive amounts of data, of which only a small portion is pertinent to the case. This complicates, prolongs and adds great expense to the collection process.

Unfortunately there exist very few options to easily filter large datasets and collect only the pertinent information. There are a few software applications to reduce the amount of email data which admittedly does make up a majority of most legal proceedings. However, there is currently nothing available that will quickly, easily and inexpensively reduce the total amount of data to a manageable size.

The system can comprise an optional plugin that can be used to quickly and easily reduce the data in a case. The e-discovery plugin can expedite the e-discovery process and save clients money. The plugin implements search algorithms to reduce and remove the nonresponsive data. The plugin is capable of isolating files by date/time stamps, keywords, container files (email, zip files, etc), and de-duplicate files by hash value. Preferably the plugin operates with two things in mind: accuracy and speed. The plugin may eliminate approximately 90% of non-responsive data. This translates to cost savings for the customer. As an example, instead of processing 2 terabytes of data, using the plugin the data requiring expensive processing can be reduced to 200 gigabytes, producing a considerable cost savings to the client. Preferably, the plugin can process between 500 MB and 1 GB per minute.

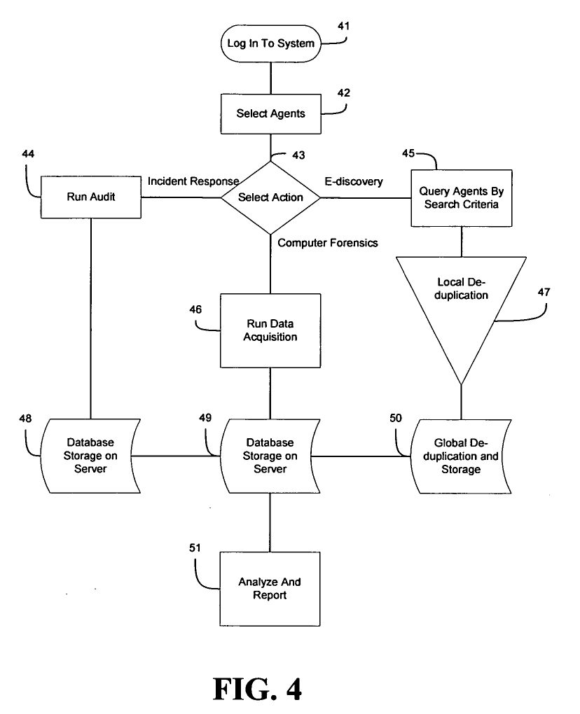

Referring to FIG. 4, a flowchart illustrates some of the exemplary steps that may be carried out with this system. A user will generally log into 41 the system using credentials that will have been assigned appropriate permission levels. The user will be presented with a list of agents that the user may access. Active agents will be indicated. The user can select from several actions including incident response audit, collection of forensic data, and compiling an e-discovery response. For incident response, the user may run an audit 44 of system events and data reported by agents and stored in a server database 48. The user may conduct a forensic investigation 46 on one or more agents by selecting data items to be collected by the agents and transmitting commands to the agents and receiving data from the agents through their associated servers 49. The user may also conduct an e-discovery 45 by commanding the agents to search for and collect data matching specified criteria. The agents and each level of the server hierarchy may conduct de-duplication 47 of the collected data so that the server storage only contains a single instance of a particular data item.

Corporations across the globe rely on data networks to operate and achieve their business objectives. Malicious insiders and hackers pose a significant threat to data, technology and the survivability of the corporation. Focus on the external threat and layered defenses are effective against external threats, but do very little to mitigate threat of rogue insiders or the unsafe network practices of employees. This enterprise solution can offer a strong defense against the rogue insider or compromised system. This enterprise solution can provide proven and forensically sound real-time monitoring capabilities to allow network defense analysts to defend the organization's data and technology. This enterprise solution can reduce incident response from days to minutes and provides vital digital evidence needed to identify the malicious insider or compromised system. In litigation, the enterprise solution can reduce expenses related to e-discovery.

While the invention has been described in detail with reference to preferred embodiments thereof, it will be apparent to one skilled in the art that various changes can be made, and equivalents employed, without departing from the scope of the invention.

What is claimed is:

1. A method for collecting volatile data from an active target computer, comprising:
selecting one or more computer forensic data items, including at least one volatile data item, to be collected from an active target computer from among a plurality of computer forensic data items;
generating executable runtime code comprising one or more data collection modules for collecting the selected computer forensic data items from an active target computer wherein the executable runtime code is configured such that once activated on an active target computer the executable runtime code is capable of launching said modules in a defined sequence from a removable storage device without further user input;
storing the executable runtime code on an initialized removable storage device;
connecting the removable storage device to an active target computer; and, activating the executable runtime code to collect the selected computer forensic data items from the active target computer.

2. The method of claim 1, wherein the removable storage device is configured such that connecting the removable storage device to an active target computer causes the executable runtime code to be activated automatically.

3. The method of claim 1, wherein, at the time that the executable runtime code is activated, a user can command the runtime code to either store the data items to be collected on the removable storage medium or securely transmit the data items to an internet drop site.

4. The method of claim 1, further comprising deactivating and removing the removable storage medium following completion of the step of collecting the selected data items, wherein the collected data items are stored on the removable storage medium in an encrypted database that is recoverably deleted prior to deactivation and removal of the removable storage medium.

5. The method of claim 1, wherein the removable storage device is a USB flash drive.

6. The method of claim 5, wherein the USB flash drive comprises a writeable partition and a read-only partition.

7. The method of claim 6, wherein the USB flash drive comprises U3 technology and storing the executable runtime code and tools on an initialized removable storage device comprises programming the read-only portion of the thumb drive with a custom launch program.

8. The method of claim 1, wherein the data is collected covertly.

9. The method of claim 8, further comprising displaying a camouflaged view to the user while the data is being collected.

10. The method of claim 9, wherein the camouflaged view appears to be a view selected from among a web browser, a card game, and an image browser.

11. The method of claim 8, wherein the data is collected without any change to the target computer display.

12. A system for collecting and managing data relating to the activity of a user of a networked host computer, comprising:
a plurality of software agents, each agent active on a host computer system;
one or more servers, each server in network communication with one or more of said software agents; and,
one or more console administrative tools residing on computer systems capable of network communication with said servers;
wherein said software agents each comprise means for covertly and forensically searching and collecting volatile data from the system upon which the software agent resides and securely transmitting requested data to one of said servers,
wherein said servers each comprise means for securely storing data received from one or more of said software agents, means for securely receiving instructions from a console administrative tool subject to an administrative permission rule, means for securely transmitting instructions to one or more agents, and means of transmitting forensic data to said console administrative tools; and
wherein said console administrative tools each comprise means of securely communicating with said servers, means of requesting forensic data from said servers and agents, and means of verifying, analyzing and presenting forensic data received from said software agents through said servers.

13. The system of claim 12, wherein said software agents comprise means for limiting the agents' use of network and host computer resources so as to avoid negatively impacting network or host computer performance.

14. The system of claim 12, wherein said servers that are in network communication with said agents comprise a plurality of local servers, the system further comprising one or more supervisory servers in network communication with said plurality of local servers, wherein one or more of said software agents is in a different network region from one or more other of said software agents and wherein the software agents in different network regions are associated with different local servers.

15. The system of claim 12, wherein user access permissions granted to each user of a console administrative tool define limits for accessing agents within the network and their respective data.

16. The system of claim 12, wherein the consoles can command the agents to collect a complete image of the volatile data their host criteria.

17. The system of claim 12, wherein the agents covertly collect the data from the computer by camouflaging as a routine process on the computer.

18. The system of claim 12, wherein the agents do not use any system application program interface calls to collect the data.

19. The system of claim 12, wherein all network communications among and between agents, servers, and consoles are encrypted.

20. The system of claim 12, wherein the servers each comprise a means of securely storing an audit log for archiving all user activity and system events for each agent and console in communication with said server.

21. The system of claim 12, wherein some or all of the agents are deployed to host computers using a software deployment or patch management solution.

22. The system of claim 12, wherein the servers comprise a module for deploying software agents.

23. The system of claim 12, comprising a software agent running from a live CD.

24. A method for collecting and managing data relating to the activity of a user of a networked in a network system comprising:
deploying software agents for collecting computer forensic data from host computers on the network system on which the agents reside, the agents being in networked communication with a server, and one or more of said servers being in network communication with a console administrative tool;
causing a console administrative tool to transmit instructions to one or more agents through the servers that are in communication with those agents instructing those one or more said software agents to covertly and forensically collect forensic data including at least one item of volatile data from the computers upon which on those software agents are active; and
storing the data on a server for analysis.

25. The method of claim 24, wherein each software agent is configured to retrieve data of one or more user specified types from the one or more computers according to specified search criteria.

26. The method of claim 24, wherein the software agent is camouflaged as a routine process on the computer.

27. The method of claim 24, wherein the data is collected by the software agent without using any system application program interface (API) calls.

28. The method of claim 24, further comprising securely archiving user activity and system events recorded by a software agent to a server.

29. The method of claim 28, comprising building a case comprising said archived activity without alerting the user of the host computer on which a software agent resides to the data collection.

30. The method of claim 24, comprising compiling data responsive to a litigation discovery requirement by instructing the agents to collect and transmit data satisfying specific search criteria.
